(19) United States
(12) Patent Application Publication
(10) Pub. No.: US 2026/0087455 A1
(43) Pub. Date: Mar. 26, 2026

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventor: Takahiro SHIMIZU, Tokyo (JP)

(21) Appl. No.: 19/297,958

(22) Filed: Aug. 12, 2025

(30) Foreign Application Priority Data
Sep. 20, 2024 (JP) 2024-164378

(51) Int. Cl. G06Q 10/101; G06Q 30/0601; G06Q 50/00

(52) U.S. Cl. CPC G06Q 10/101; G06Q 10/40; G06Q 30/06031

(57) ABSTRACT

An information processing apparatus includes a registration unit 131 that, in response to a request from a business operator who operates a business operator account that is an account for a business operator and that is created in a mobile messenger application, registers, in an associated manner, a plurality of the business operator accounts that are linked to each other as a business community; and a providing unit 132 that provides information on the business community to a user of the mobile messenger application that is able to exchange messages with the official accounts based on information on the business operator who belongs to the business community.

### CROSS-REFERENCE TO RELATED APPLICATIONS

The present application claims priority to and incorporates by reference the entire contents of Japanese Patent Application No. 2024-164378 filed in Japan on Sep. 20, 2024.

### BACKGROUND OF THE INVENTION

### 1. Field of the Invention

The present application relates to an information processing apparatus, an information processing method, and a non-transitory computer readable storage medium having stored therein an information processing program.

### 2. Description of the Related Art

Conventionally, a mobile messenger is widely used as one of communication tools that are available to mobile communication terminals. For example, in relation to a mobile messenger, a technology for transferring voice messages among participants in a chat using the mobile messenger has been proposed (for example, see Japanese Laid-open Patent Publication No. 2007-295576).

However, in the conventional technology, there is room for improvement in improving usability of a mobile messenger.

### SUMMARY OF THE INVENTION

An information processing apparatus includes a registration unit that, in response to a request from a business operator who operates a business operator account that is an account for a business operator and that is created in a mobile messenger application, registers, in an associated manner, a plurality of the business operator accounts that are linked to each other as a business community; and a providing unit that provides information on the business community to a user of the mobile messenger application that is able to exchange messages with the official accounts based on information on the business operator who belongs to the business community.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for explaining an example of information processing (first example) according to one embodiment;

FIG. 2 is a diagram for explaining an example of information processing (second example) according to one embodiment;

FIG. 3 is a diagram illustrating an image of service provision according to one embodiment;

FIG. 4 is a diagram illustrating an image of service provision according to one embodiment;

FIG. 5 is a diagram illustrating a system configuration example of an information processing system according to one embodiment;

FIG. 6 is a diagram illustrating a configuration example of an information processing apparatus according to one embodiment;

FIG. 7 is a diagram illustrating an overview of business operator information that is stored in a business operator information storage unit according to one embodiment;

FIG. 8 is a diagram illustrating an overview of link information that is stored in a link information storage unit according to one embodiment;

FIG. 9 is a diagram illustrating an overview of alliance information that is stored in an alliance information storage unit according to one embodiment;

FIG. 10 is a flowchart illustrating an example of the flow of information processing (first example) that is performed by the information processing apparatus according to one embodiment;

FIG. 11 is a flowchart illustrating an example of the flow of information processing (second example) that is performed by the information processing apparatus according to one embodiment;

FIG. 12 is a flowchart illustrating an example of the flow of information processing (third example) that is performed by the information processing apparatus according to one embodiment; and

FIG. 13 is a hardware configuration diagram illustrating an example of a computer that implements functions of the information processing apparatus according to one embodiment.

### DETAILED DESCRIPTION OF THE PREFERRED EMBODIMENTS

Modes (hereinafter, described as “embodiments”) for carrying out an information processing apparatus, an information processing method, and an information processing program according to the present application will be described in detail below with reference to the drawings. Meanwhile, the information processing apparatus, the information processing method, and the information processing program according to the present application are not limited by the embodiments below. Further, the embodiments may be appropriately combined as long as processing contents do not conflict with each other. Furthermore, in each of the embodiments described below, the same components are denoted by the same reference symbols, and repeated explanation will be omitted.

### EMBODIMENT

### 1. Example of Information Processing

### 1-1. Information Processing (First Example)

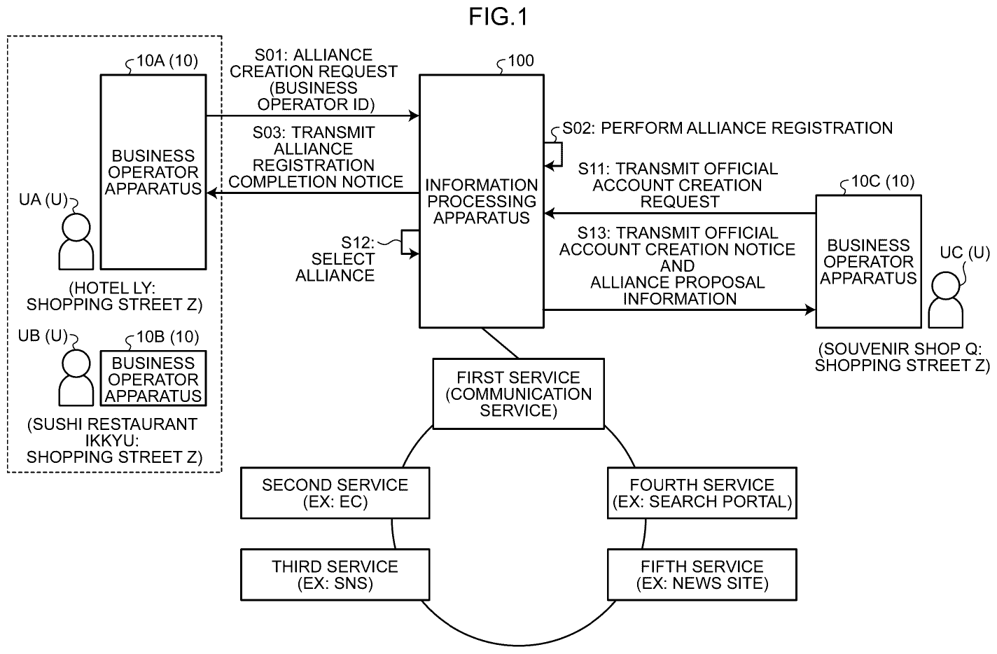

An example of information processing according to one embodiment will be described below with reference to the drawings. First, an overview of information processing (first example) according to one embodiment will be described with reference to FIG. 1. FIG. 1 is a diagram for explaining an example of the information processing (first example) according to one embodiment. The information processing (first example) described below is performed to provide a scheme for providing a consistent service among business operators who have official accounts while adopting a communication service using a mobile messenger as a platform, and improve usability of the official accounts in a mobile messenger service.

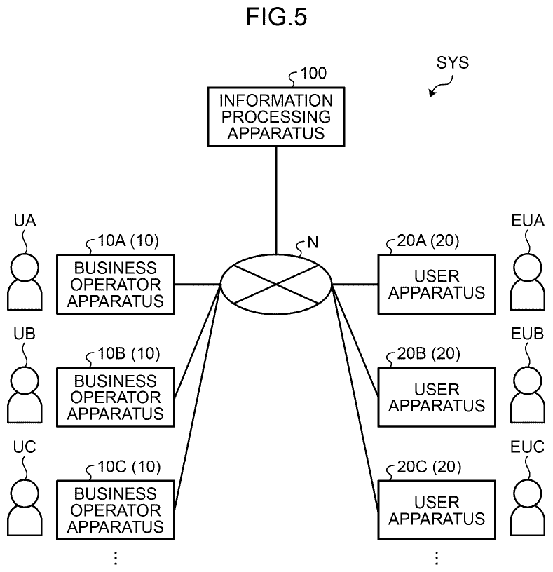

The information processing (first example) according to one embodiment is implemented by an information processing system SYS (for example, see FIG. 5) that includes a business operator apparatus 10A, a business operator apparatus 10B, and a business operator apparatus 10C illustrated in FIG. 1 and an information processing apparatus 100 illustrated in FIG. 1. Each of the business operator apparatuses 10A to 10C and the information processing apparatus 100 is connected to a network N (for example, see FIG. 5) in a wired or wireless manner. The business operator apparatuses 10A to 10C and the information processing apparatus 100 are able to communicate with the other apparatuses via the network N.

Meanwhile, in the following explanation, when the business operator apparatus 10A, the business operator apparatus 10B, and the business operator apparatus 10C need not be specifically distinguished from one another, they are collectively referred to as a “business operator apparatus 10”. Further, when a business operator UA, a business operator UB, and a business operator UC need not be specifically distinguished from one another, they are collectively referred to as a “business operator U”.

The business operator apparatus 10 is used by the business operator U. In the business operator apparatus 10, a mobile messenger application (hereinafter, appropriately referred to as a “messenger application”) that is an application program for using a mobile messenger is installed in advance. The business operator U is one example of a business operator who operates an official account (also referred to as a “business operator account”) as an account that is for the business operator and that is created in the mobile messenger application.

The official account is a verified account that is verified by a service provider of the communication service that is implemented via the messenger application. The official account is able to exchange messages with a user who has registered the official account as a friend in the communication service as described above, which is different from a normal account in the message application. Further, the official account is able to provide a shop card, provide a chart service using generative Artificial Intelligence (AI), or distribute an advertising message. The generative AI is implemented by, for example, Artificial Intelligence (AI), such as Generative Pre-trained Transformer (GPT). The GPT is a language model that is able to generate a sentence by a technology of natural language processing.

Furthermore, the communication service as described above enables setting of an alliance (one example of a “business community”) in which the official accounts are associated with one another. With this configuration, the business operator U who operates the official account is able to cooperate with the different business operator U as the alliance.

For example, the business operator apparatus 10A transmits an alliance creation request to the information processing apparatus 100 in accordance with operation that is performed by the business operator UA (Step S01). The alliance creation request includes a business operator ID for identifying a business operator UA who operates an official account that has issued the alliance creation request, and a business operator ID for identifying a business operator UB who operates a linked official account.

The information processing apparatus 100, when receiving the alliance creation request, performs alliance registration (Step S02). For example, the information processing apparatus 100 registers, in association with an alliance ID (one example of “community identification information”) for identifying the alliance, a business operator account (business operator ID) of the business operator UA and a business operator account (business operator ID) of the business operator UB who cooperate with each other as the alliance.

Furthermore, at the time of the alliance registration, the information processing apparatus 100 may generate, as alliance information, information that indicates a name of the alliance or information that indicates an attribute of the alliance, and registers the alliance information in association with the alliance ID. The attribute of the alliance corresponds to information indicating what type of business operators U (official accounts) belong to the alliance, information indicating areas in which the business operators U belonging to the alliance are located, information indicating business categories (industries, business types, or the like) of the business operators U belonging to the alliance. Meanwhile, the attribute of the alliance may be received from and registered by the business operators U who belong to the alliance, or may be estimated and set by generative AI based on information on each of the business operators who belong to the alliance.

After completion of the alliance registration, the information processing apparatus 100 transmits an alliance registration completion notice to the business operator apparatus 10A (Step S03).

The business operator UA checks the alliance registration completion notice that is transmitted from the information processing apparatus 100, and thereafter, cooperates with the business operator UB as the alliance.

Moreover, the business operator apparatus 10C transmits an official account creation request to the information processing apparatus 100 in accordance with operation that is performed by a business operator UC (Step S11). The business operator UC is a new business operator who newly creates an official account.

The information processing apparatus 100, when receiving the official account creation request, performs a verification process based on information on the business operator US included in the creation request, and grants an official account to the business operator UC when the verification is successful.

Furthermore, the information processing apparatus 100 is able to provide a function to create a new alliance and a function to joining an existing alliance to the business operator UC who has created the official account. For example, the information processing apparatus 100 is able to provide the function to create a new alliance and the function to joining an existing alliance to the business operator UC, as a part of functions that are included in the messenger application or a part of functions that are included in a predetermined tool that is provided from the service provider of the communication service to the business operator U. The business operator UC is able to transmit the alliance creation request as described above to the information processing apparatus 100, by, for example, using the function to create a new alliance by operating the messenger application or the predetermined tool. Moreover, the business operator UC is able to transmit the request to join an existing alliance to the information processing apparatus 100 by, for example, using the function to joining an existing alliance by operating the messenger application or the predetermined tool. The information processing apparatus 100, when, for example, receiving the request to join an existing alliance from the business operator UC, notifies the official account that has set the corresponding alliance that the request to join the alliance is issued, and mediate joining the alliance.

Furthermore, the information processing apparatus 100 selects an alliance that matches an attribute of the business operator UC from among existing alliances based on attributes of the existing alliances and the attribute of the business operator UC who has newly created the official account (Step S12). For example, in the example illustrated in FIG. 1, a location of the business operator UC who has newly opened the official account is a “shopping street Z”, and therefore, the information processing apparatus 100 is able to select an alliance to which the business operator UA and the business operator UB with the same attributes of the “shopping street Z” belong.

After selecting the alliance, the information processing apparatus 100 transmits an official account creation notice and alliance proposal information for proposing participation in the alliance to the business operator apparatus 10C (Step S13), and provides the official account creation notice and the alliance proposal information to the business operator UC.

The business operator UC is able to consider participating in the alliance with reference to the alliance proposal information that is received from the information processing apparatus 100.

As described above, the information processing apparatus 100 according to one embodiment is able to set an alliance in which official accounts are linked to each other, and provide, to a new business operator who has created an official account for example, proposal information for proposing participation in the alliance. In this manner, the information processing apparatus 100 is able to improve usability of the official account in the mobile messenger service.

Furthermore, the communication service that is provided as a first service and a plurality of services other than the communication service are linked to each other in advance. For example, user IDs that are assigned to identify users in each of the communication service that is provided as the first service, Electronic Commerce (EC) that is provided as a second service (Electronic Commerce), a Social Networking Service (SNS) that is provided as a third service, a search portal that is provided as a fourth service, and a news site that is provided as a fifth service are associated with one another.

The information processing apparatus 100 is able to provide information based on each of the services to the official account through the user ID of the user of the communication service. For example, the information processing apparatus 100 acquires attribute information that indicates an attribute of a user in each of the services or an action history based on the user ID of each of users who have registered each of the official accounts that belong to the alliance as a friend, and generates statistical information based on the acquired attribute information or the acquired action history. For example, the information processing apparatus 100 is able to generate various kinds of statistical information that indicates an age group, gender, a place of residence, a content of a different service in use, a trend of an average payment amount in a different service, or the like, with respect to each of the users who have registered each of the official accounts that belong to the alliance as a friend. Further, the information processing apparatus 100 provides the generated statistical information to each of the official accounts.

Furthermore, the information processing apparatus 100 may acquire an action history of a user based on each of the service on the basis of the user ID of each of users who have registered a first official account that belongs to the alliance as a friend, and generate statistical information based on the acquired action history. Moreover, the information processing apparatus 100 may provide the statistical information on each of the users who have registered the first official account as a friend to a second official account that belongs to the same alliance.

Furthermore, the information processing apparatus 100 may calculate a degree of contribution made by the alliance to each of business operators based on the number of achievements of predetermined conversion (for example, registration as a friend) from the alliance, and earn a predetermined commission fee from each of the business operators based on the calculated degree of contribution. For example, it is assumed that the information processing apparatus 100 provides information on an alliance to which the business operator UA, the business operator UB, and the business operator UC belong, and 50 people register the business operator UA as friends, 30 people register the business operator UB as friends, and 20 people register the business operator UC as friends. In this case, the information processing apparatus 100 calculates that the degree of contribution made by the alliance to the business operator UA is 50%, the degree of contribution made by the alliance to the business operator UB is 30%, and the degree of contribution made by the alliance to the business operator UC is 20%. Then, the information processing apparatus 100 calculates a commission fee for each of the business operators U by distributing an advertisement cost that is incurred by provision of the alliance information, and collects the calculated commission fee from each of the business operators U.

Moreover, for example, when distributing an advertisement of the business operator UB in the official account of the business operator UA and the business operator UB is registered as a friend, the information processing apparatus 100 may acknowledge a contribution of the business operator UA. In this case, the information processing apparatus 100 is able to give, as an expense that is needed for distribution of the advertisement, a part of the commission fee that is collected from the business operator UB to the business operator UA in accordance with the degree of contribution of the business operator UA.

### 1-2. Information Processing (Second Example)

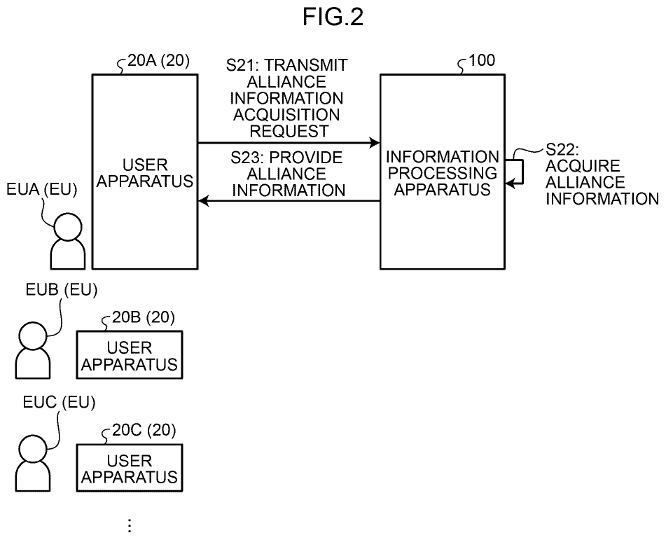

An overview of information processing (second example) according to one embodiment will be described below with reference to FIG. 2. FIG. 2 is a diagram for explaining an example of the information processing (second example) according to one embodiment. The embodiment described below is aimed at improving usability of a mobile messenger service by providing a scheme for providing a consistent service among business operators who have official accounts while adopting a communication service using a mobile messenger as a platform.

The information processing (second example) according to one embodiment is implemented by the information processing system SYS (for example, see FIG. 5) that includes a user apparatus 20A, a user apparatus 20B, and a user apparatus 20C illustrated in FIG. 2 and the information processing apparatus 100 illustrated in FIG. 2. Each of the user apparatuses 20A to 20C and the information processing apparatus 100 is connected to the network N (for example, see FIG. 5) in a wired or wireless manner. The user apparatuses 20A to 20C and the information processing apparatus 100 are able to communicate with the other apparatuses via the network N.

Meanwhile, in the following explanation, when the user apparatus 20A, the user apparatus 20B, and the user apparatus 20C need not be specifically distinguished from one another, they are collectively referred to as a “user apparatus 20”. Further, when a user EUA, a user EUB, and a user EUC need not be specifically distinguished from one another, they are collectively referred to as a “user EU”.

The user apparatus 20 is used by the user EU. In the user apparatus 20, a messenger application is installed in advance. A normal account of the message application is granted to the user EU.

For example, the user EUA activates the messenger application by operating the user apparatus 20A, and transmits an alliance information acquisition request to the information processing apparatus 100 via the messenger application (Step S21).

For example, by selecting a thumbnail corresponding to a desired alliance from an alliance list that is displayed on a predetermined screen of the messenger application, the user EUA is able to transmit the acquisition request for alliance information corresponding to the selected thumbnail to the information processing apparatus 100.

Meanwhile, when providing the alliance list to the user EUA via the messenger application, the information processing apparatus 100 may estimate a degree of conformity between an attribute of the alliance and an attribute of the user EUA, and selects information on an alliance for which the estimated degree of conformity is high as target information to be provided to the user EUA. For example, when a location area of the alliance EX1 includes a place of residence of the user EUA, the information processing apparatus 100 is able to estimate that the degree of conformity between the alliance EX1 and the user EUA is high. The information processing apparatus 100 may estimate the degree of conformity by using a trained model or may perform estimation based on a rule base that is set in advance.

The information processing apparatus 100, when receiving the alliance information acquisition request from the user apparatus 20A, acquires alliance information corresponding to the acquisition request (Step S22). For example, the information processing apparatus 100 acquires, as the alliance information, information (a name (for example, a store name) of an official account, a URL of a home screen, or the like) on an official account that belongs to the alliance. Further, the information processing apparatus 100 provides the acquired alliance information to the user EUA by transmitting the acquired alliance information to the user apparatus 20A (Step S23). For example, by transmitting the alliance list to the user EUA, the information processing apparatus 100 is able to provide, as the alliance information, the account list in which official accounts that are included in the subject alliance are listed to the user apparatus 20A.

Furthermore, when providing the account list to the user EUA, the information processing apparatus 100 may estimate a degree of conformity between attributes of official accounts that belong to the subject account list and the attribute of the user EUA, re-arrange the account list such that an official account with the attribute for which the estimated degree of conformity is higher is displayed with higher priority, and provide the re-arranged account list. For example, when an age group of each of users who have registered the subject official account as friends includes the age of the user EUA, the information processing apparatus 100 is able to estimate that the degree of conformity between the attribute of the official account and the attribute of the user EUA is high. Further, for example, when the place of residence of the user EUA is included in the neighborhood of a location area of the business operator U who operates the subject official account, the information processing apparatus 100 is able to estimate that the degree of conformity between the attribute of the official account and the attribute of the user EUA is high.

Furthermore, when receiving a request to acquire information on the official account from the user EUA, the information processing apparatus 100 may select, as an official account for which information is to be provided to the user EUA, a different official account that is included in the alliance to which the official account registered as a friend by the user EUA belongs and that is not registered as a friend by the user EUA. Moreover, in this case, the information processing apparatus 100 may make a proposal to the user EUA to register the selected official account as a friend, automatically register the user EUA as a friend of an official account that is not registered as a friend by the user EUA, or make an inquiry to the user EUA and perform registration as a friend if approved.

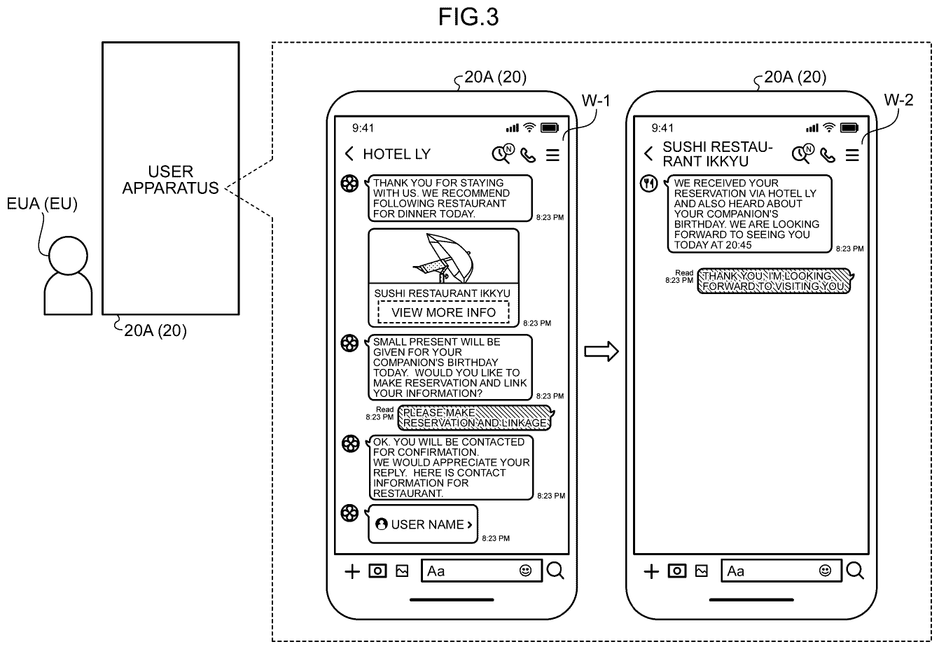

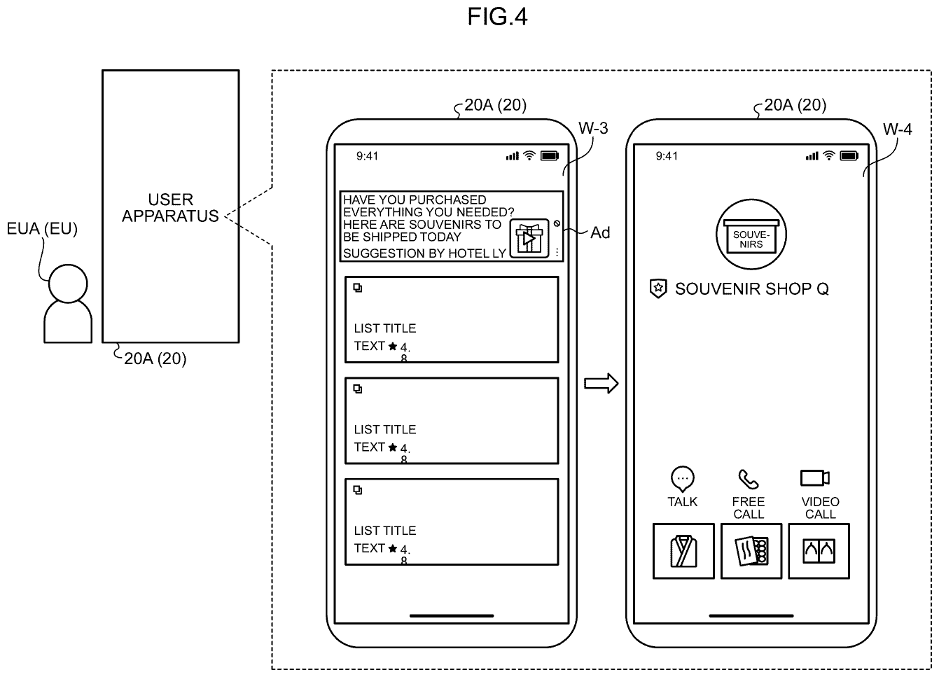

Furthermore, when receiving a request for the second official account in the alliance to which the first official account belongs via a predetermined screen through which the user EUA and the first official account exchange messages, the information processing apparatus 100 may link information on the request to the second official account. Specific images of a service will be described below with reference to FIG. 3 and FIG. 4. FIG. 3 and FIG. 4 are diagrams illustrating images of service provision according to one embodiment.

As illustrated in FIG. 3, the user EUA displays, on the user apparatus 20A, a talk screen W-1 (one example of a “predetermined screen”) of an official account of [hotel LY] that is registered as a friend, and exchanges messages with the official account of [hotel LY] via the talk screen W-1. Here, the user EUA makes a request for reservation of [sushi restaurant ikkyu] that belongs to the same alliance as the official account of [hotel LY] and linkage of the user information in response to a proposal that is made by [hotel LY] while exchanging messages with the official account of [hotel LY]. In this case, the information processing apparatus 100 links information on the request in the talk screen W-1 to the official account of [sushi restaurant ikkyu]. For example, the information processing apparatus 100 links information on a reservation date and time and information on the user EUA to the official account of [sushi restaurant ikkyu]. The user EUA is able to display a talk screen W-2 of the official account of [sushi restaurant ikkyu] on the user apparatus 20A, and view a reservation confirmation message that is transmitted from [sushi restaurant ikkyu] via the talk screen W-2.

Furthermore, as illustrated in FIG. 4, when the user EUA has registered the official account of [hotel LY] as a friend, the information processing apparatus 100 is able to provide advertising information Ad on [souvenir shop Q] that belongs to the same alliance as the official account of [hotel LY] via a predetermined screen W-3 of the messenger application. For example, the information processing apparatus 100 may adopt, as a condition, a case in which the official account of [hotel LY] and the official account of [souvenir shop Q] are linked to each other in terms of distribution of respective advertisements. When the user EUA selects the advertising information Ad, the user apparatus 20A displays a home screen W-4 of the official account of [souvenir shop Q].

As described above, the information processing apparatus 100 according to one embodiment is able to provide information on an alliance or information on an official account to a user (for example, the user EUA or the like) through the messenger application, and provides a seamless user experience in the communication service. In this manner, the information processing apparatus 100 is able to improve usability of the mobile messenger service.

### 2. System Configuration

A configuration of the information processing system SYS according to one embodiment will be described below with reference to FIG. 5. FIG. 5 is a diagram illustrating a system configuration example of the information processing system SYS according to one embodiment.

As illustrated in FIG. 5, the information processing system SYS according to one embodiment includes the plurality of business operator apparatuses 10, such as the business operator apparatus 10A, the business operator apparatus 10B, and the business operator apparatus 10C, the plurality of user apparatuses 20, such as the user apparatus 20A, the user apparatus 20B, and the user apparatus 20C, and the information processing apparatus 100. Meanwhile, FIG. 5 illustrates only one example of the configuration of the information processing system SYS according to one embodiment, and the information processing system SYS may include a different apparatus, such as a service providing apparatus, that executes a process related to a portal site that provides various kinds of online services.

The business operator apparatuses 10, the user apparatuses 20, and the information processing apparatus 100 are connected to the network N in a wired or wireless manner. Each of the business operator apparatuses 10, the user apparatuses 20, and the information processing apparatus 100 are able to communicate with the other apparatuses via the network N.

The network N includes, for example, a Wide Area Network (WAN), such as the Internet, a mobile communication network, such as Long Term Evolution (LTE), 4th Generation (4G), or 5th Generation Mobile Communication System (5G), or the like.

The business operator apparatus 10 is able to connect to the network N by near field wireless communication, such as a mobile communication network, Bluetooth (registered trademark), or a wireless Local Area Network (LAN), and communicate with a different apparatus, such as the information processing apparatus 100, via the network N.

Furthermore, the business operator apparatus 10 is used by the business operator U who uses the messenger application. The business operator apparatus 10 may be, for example, a notebook Personal Computer (PC), a desktop PC, a smartphone, a tablet PC, or the like.

The business operator U is able to activate the messenger application by operating the business operator apparatus 10, and transmit an alliance creation request or the like to the information processing apparatus 100 via the messenger application. Further, the business operator U may access the information processing apparatus 100 by an Application Programming Interface (API) that is provided from a service provider that manages the information processing apparatus 100, and transmit the alliance creation request or the like via a predetermined tool that is displayed, as a user interface, on the business operator apparatus 10. The predetermined tool may be a dedicated application program equipped with various kinds of functions for performing a process, such as transmission of the alliance creation request, or may be a predetermined management screen that is displayable, as a web page, by a web browser.

Furthermore, the business operator apparatus 10 is able to display, for example, a content that is provided from the information processing apparatus 100, by a dedicated application or a web browser. Meanwhile, when receiving control information for implementing an information display process from the information processing apparatus 100, the business operator apparatus 10 performs a display process in accordance with the control information.

The control information is written in, for example, a script language, such as JavaScript (registered trademark), a style sheet language, such as Cascading Style Sheets (CSS), a programming language, such as Java (registered trademark), or a markup language, such as HyperText Markup Language (HTML). Meanwhile, it may be possible to regard, as the control information, a predetermined application itself that is distributed from the information processing apparatus 100 or the like.

The user apparatus 20 is able to connect to the network N by near field wireless communication, such as a mobile communication network, Bluetooth (registered trademark), or a wireless LAN, and communicate with a different apparatus, such as the information processing apparatus 100, via the network N.

Furthermore, the user apparatus 20 is used by the user EU who uses the messenger application. The user apparatus 20 may be, for example, a notebook PC, a desktop PC, a smartphone, a tablet PC, or the like.

The user EU is able to activate the messenger application by operating the user apparatus 20, and transmit the alliance information acquisition request or the like to the information processing apparatus 100 via the messenger application.

Further, the user apparatus 20 is able to display, for example, a content that is provided from the information processing apparatus 100, by a dedicated application or a web browser. Meanwhile, when receiving control information for implementing an information display process from the information processing apparatus 100, the user apparatus 20 performs a display process in accordance with the control information.

The control information is written in, for example, a script language, such as JavaScript (registered trademark), a style sheet language, such as Cascading Style Sheets (CSS), a programming language, such as Java (registered trademark), or a markup language, such as HyperText Markup Language (HTML). Meanwhile, it may be possible to regard, as the control information, a predetermined application itself that is distributed from the information processing apparatus 100 or the like.

The information processing apparatus 100 is operated and managed by a service provider who provides the communication service through the mobile messenger. The information processing apparatus 100 functions as an online platform that implements information processing related to a mobile messenger. The information processing apparatus 100 provides the function to create a new alliance and the function to joining an existing alliance to a verified official account.

The information processing apparatus 100 is, typically, a server apparatus, but may be implemented by a main frame, a workstation, or the like. Further, when the information processing apparatus 100 is implemented by a server apparatus, the information processing apparatus 100 may be implemented by a single server apparatus or may be implemented by a cloud system or the like in which a plurality of server apparatuses and a plurality of storage apparatuses cooperate with one another.

### 3. Apparatus Configuration

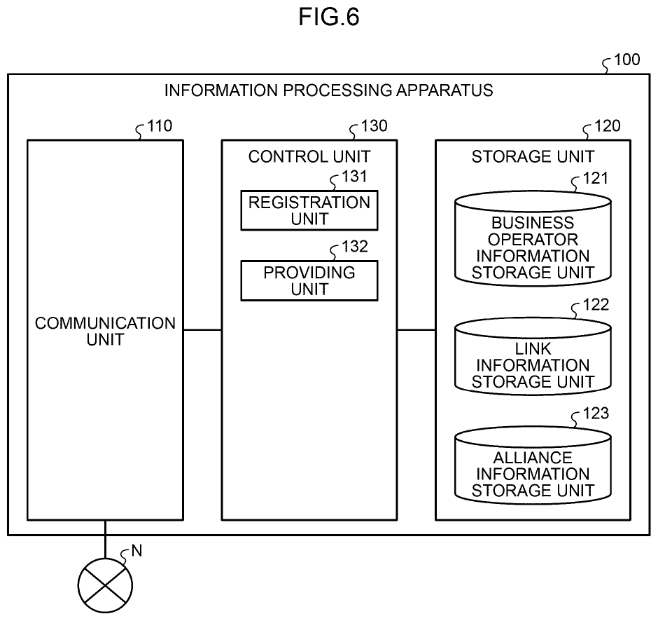

An example of a functional configuration of the information processing apparatus 100 included in the information processing system SYS according to one embodiment will be described below with reference to FIG. 6. FIG. 6 is a diagram illustrating a configuration example of the information processing apparatus 100 according to one embodiment. As illustrated in FIG. 6, the information processing apparatus 100 includes a communication unit 110, a storage unit 120, and a control unit 130.

### Communication Unit 110

The communication unit 110 is implemented by, for example, a communication module, a Network Interface Card (NIC), or the like. The communication unit 110 is connected to the network N in a wired or wireless manner. The information processing apparatus 100 transmits and receives information to and from a different apparatus, such as the business operator apparatus 10, via the network N.

### Storage Unit 120

The storage unit 120 stores therein, for example, a program and data that are used for control and calculations performed by the control unit 130. For example, the storage unit 120 is implemented by, for example, a semiconductor memory device, such as a Random Access Memory (RAM) or a Flash Memory, or a storage device, such as a hard disk or an optical disk. For example, the storage unit 120 includes a business operator information storage unit 121, a link information storage unit 122, and an alliance information storage unit 123. Meanwhile, the storage unit 120 need not always store therein data or the like illustrated in FIG. 6, but may appropriately store therein data, such as a database for storing information on users in various kinds of online services, that is needed to perform the information processing according to one embodiment. Meanwhile, a search history in various kinds of online services may be acquired form a different system if needed.

### Business Operator Information Storage Unit 121

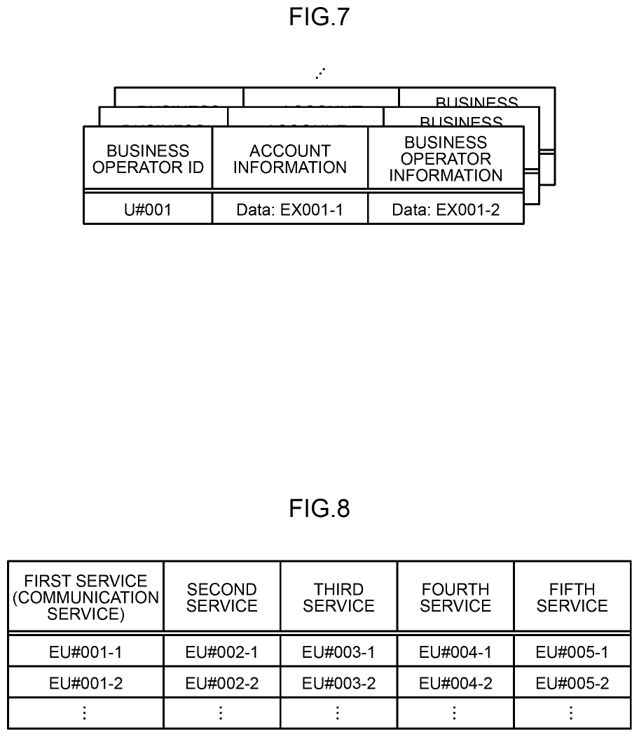

The business operator information storage unit 121 stores therein business operator information on the business operator U who is a user of the communication service through the messenger application. FIG. 7 is a diagram illustrating an overview of the business operator information that is stored in the business operator information storage unit 121 according to one embodiment.

As illustrated in FIG. 7, the business operator information stored in the business operator information storage unit 121 includes a plurality of items, such as an item of a “business operator ID”, an item of “account information”, and an item of “business operator information”. The items that are included in the business operator information are associated with one another.

In the item of the “business operator ID”, identification information for identifying the business operator U in the communication service is stored. In the item of the “account information”, information on an official account that is user by a business operator in the communication service is stored. In the item of the “business operator information”, information on an industry, a business type, a business site, or the like of the business operator U is stored.

### Link Information Storage Unit 122

The link information storage unit 122 stores therein link information in which the communication service using the messenger application and a plurality of services other than the communication service are liked in advance. FIG. 8 is a diagram illustrating an overview of the link information that is stored in the link information storage unit 122 according to one embodiment.

The link information that is stored in the link information storage unit 122 is configured such that information on each of users of the first service that is the communication service and information on each of users of the second service, the third service, the fourth service, and the fifth service other than the communication service are linked to each other. For example, in the example illustrated in FIG. 8, as the link information that is stored in the link information storage unit 122, user IDs that are assigned to identify users in each of services such as the communication service that is provided as the first service, EC that is provided as the second service, an SNS that is provided as the third service, a search portal that is provided as the fourth service, and a news site that is provided as the fifth service are associated with one another.

For example, a service user who provides the communication service via the messenger application collects, with respect to a user of the communication service, user IDs for services other than the communication service and registers the collected user IDs in association with the user ID of the communication service. The control unit 130 is able to use the link information that is stored in the link information storage unit 122 when generating statistical information that indicates a trend of users who have registered the official account as friends.

### Alliance Information Storage Unit 123

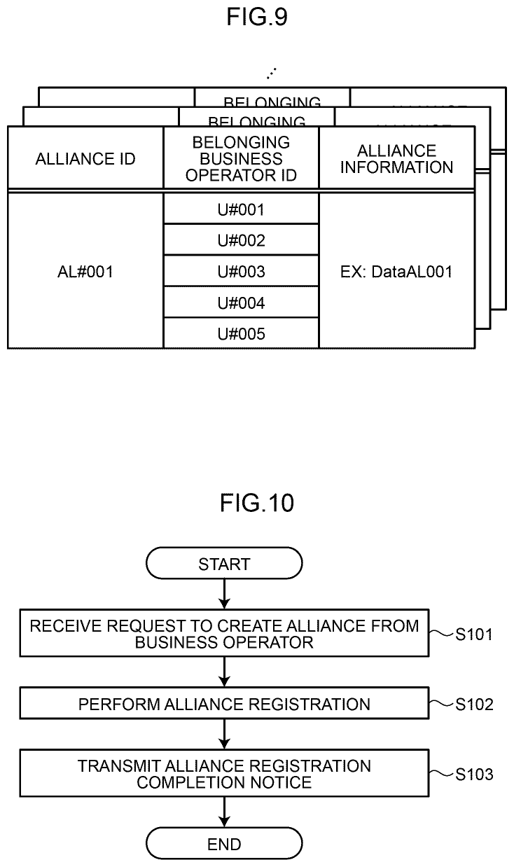

The alliance information storage unit 123 stores therein alliance information on an alliance in which official accounts are associated with one another in the communication service. FIG. 9 is a diagram illustrating an overview of the alliance information that is stored in the alliance information storage unit 123 according to one embodiment.

As illustrated in FIG. 9, the alliance information that is stored in the alliance information storage unit 123 includes a plurality of items, such as an item of an “alliance ID”, an item of a “belonging business operator ID”, and an item of “alliance information”. The items that are included in the alliance information are associated with one another.

In the item of the “alliance ID #, an alliance ID that is identification information that is uniquely assigned to each of alliances to identify the alliance is stored. In the item of the “belonging business operator ID”, a business operator ID for identifying a business operator who operates the official account that participates in the alliance is stored. In the item of the “alliance information”, information on the alliance is stored.

The information on the alliance includes information indicating a name of the alliance, information indicating an attribute of the alliance, or the like. The attribute of the alliance corresponds to information indicating what type of business operators U (official accounts) belong to the alliance, information indicating areas in which the business operators U belonging to the alliance are located, information indicating business categories (industries, business types, or the like) of the business operators U belonging to the alliance. Meanwhile, the attribute of the alliance may be received from and registered by the business operators U who belong to the alliance, or may be estimated and set by generative AI based on information on each of the business operators who belong to the alliance.

Meanwhile, the generative AI in this case is implemented by, for example, Artificial Intelligence (AI), such as Generative Pre-trained Transformer (GPT). The GPT is a language model that is able to generate a sentence by a technology of natural language processing.

### Control Unit 130

The control unit 130 is a controller and implemented by, for example, causing a Central Processing Unit (CPU), a Micro Processing Unit (MPU), or the like to execute various kinds of programs (one example of an “information processing program”) that are stored in a storage device inside the information processing apparatus 100 by using a RAM as a work area.

Further, the control unit 130 may be implemented by, for example, an integrated circuit, such as an Application Specific Integrated Circuit (ASIC), a Field Programmable Gate Array (FPGA), or a General Purpose Graphic Processing Unit (GPGPU).

As illustrated in FIG. 6, the control unit 130 includes a registration unit 131 and a providing unit 132, and implements or performs functions or operation of information processing as described below.

Meanwhile, the control unit 130 may have an internal configuration that is divided in processing units for implementing or performing functions and operation of information processing as described below. Further, the control unit 130 need not always be configured as illustrated in FIG. 6, but may be configured differently as long as the information processing to be described below is performed or may include a different functional unit other than the units illustrated in FIG. 6.

### Registration Unit 131

The registration unit 131, in response to a request from the business operator U who operates an official account (one example of a “business operator account”) that is a business operator account that is created by the business operator U on the mobile messenger application, registers, in an associated manner, a plurality of official accounts that are linked to each other as an alliance (one example of a “business community”) in the storage unit 120 (the alliance information storage unit 123). For example, the registration unit 131 registers a plurality of official accounts that are linked to each other as the alliance, in association with the alliance ID for identifying the alliance.

### Providing Unit 132

The providing unit 132 provides information to the business operator U based on information related to the business operator U who belongs to the alliance.

For example, the providing unit 132 is able to select an alliance that matches an attribute of a new business operator based on the attribute of the alliance and the attribute of the new business operator who has newly created an official account, and transmit proposal information for proposing participation in the selected alliance to the business operator apparatus 10 that is used by the new business operator via the communication unit 110. Specifically, when a location of a business operator UC who has newly created an official account is a “shopping street Z”, the providing unit 132 is able to select an alliance to which the business operator UA and the business operator UB, who have the same “shopping street Z” as the attributes, belong.

Furthermore, for example, the providing unit 132 is able to provide the function to create a new alliance and the function to joining an existing alliance to the new business operator who has newly created the official account. For example, the providing unit 132 is able to provide the function to create a new alliance and the function to joining an existing alliance as a part of the functions of the messenger application or a part of a predetermined tool.

Moreover, for example, the providing unit 132 is able to provide information based on information on the scope of information disclosure that is set, in advance, by the business operator O as the scope of information to be disclosed to other official accounts. For example, the providing unit 132 is able to provide an item setting screen for setting the scope of information to be described, to the business operator UA who operates the official account. The providing unit 132 stores the information on the scope of information disclosure that is set by the business operator UA through the item setting screen in the storage unit 120 in association with the business operator ID. Furthermore, the providing unit 132, when disclosing the information on the business operator UA to the business operator UB and the business operator UC who belong to the same alliance as the business operator UA, is able to determine information to be provided to the business operator UB and the business operator UC based on the information on the scope of information disclosure of the business operator UA. For example, when the business operator UA sets, as the scope of information disclosure, only age groups and gender of users (for example, the user EUA, the user EUB, the user EUC, and the like illustrated in FIG. 2) who have registered the official account of the business operator UA as friends, it is possible to provide only information on the age groups and the gender of the business operator UB and the business operator UC.

Moreover, the providing unit 132 provides information on the alliance to the user EUA of the mobile messenger application that is able to exchange messages with the official account, based on information related to the business operator U who belongs to the alliance.

Furthermore, when receiving a request to acquire the information on the alliance from the user EUA, the providing unit 132 is able to estimate the degree of conformity between the attribute of the alliance and the attribute of the user, and selects information on the alliance for which the estimated degree of conformity is high as target information that is to be provided to the user EUA.

Specifically, when the location area of an alliance EX1 includes the place of residence of the user EUA, the providing unit 132 is able to estimate that the degree of conformity between the alliance EX1 and the user EUA is high. The information processing apparatus 100 may estimate the degree of conformity by using a trained model, or may estimate the degree of conformity based on a rule base that is set in advance. Further, the providing unit 132 acquires, as the alliance information, information (a name (for example, a store name) of the official account or a URL of a home screen) on the official account that belongs to the alliance, and provides the acquired alliance information to the user EUA by transmitting the acquired alliance information to the user apparatus 20A via the communication unit 110. For example, the providing unit 132 is able to provide, as the alliance information, an account list in which official accounts that are included in the subject alliance are listed to the user EUA.

Furthermore, when providing the account list to the user EUA, the providing unit 132 may estimate the degree of conformity between attributes of the official accounts that belong to the subject account list and the attribute of the user EUA, re-arrange the account list such that an official account with the attribute for which the estimated degree of conformity is higher is displayed with higher priority, and provide the re-arranged list. For example, when an age group of each of the users who have registered the subject official account as friends includes the age of the user EUA, the providing unit 132 is able to estimate that the degree of conformity between the attribute of the official account and the attribute of the user EUA is high. Moreover, for example, when the place of residence of the user EUA is included in the neighborhood of the location area of the business operator U who operates the subject official account, the providing unit 132 is able to estimate that the degree of conformity between the attribute of the official account and the attribute of the user EUA is high.

Furthermore, when receiving a request to acquire information on the official account from the user, the providing unit 132 may select, as an official account for which information is to be provided to the user, a different official account that is included in the alliance to which the official account registered as a friend by the user belongs and that is not registered as a friend by the user.

Moreover, when receiving a request for the second official account in the alliance to which the first official account belongs via a predetermined screen through which the user and the first official account exchange messages, the providing unit 132 is able to link information on the request to the second official account. In other words, the providing unit 132 links information on users in relation to provision of a transaction target, such as a product or a service, by official accounts that belong to the same alliance, and supports customer transfer between the official accounts.

For example, it is assumed that the user EUA who has registered the official account of [hotel LY] as a friend exchanges messages with the official account of [hotel LY] via the talk screen W-1 (one example of the “predetermined screen”, see FIG. 3) of the official account of [hotel LY]. In this case, when the user EUA makes a request for reservation of [sushi restaurant ikkyu] that belongs to the same alliance as the official account of [hotel LY] and linkage of the user information in response to a proposal that is made by [hotel LY] while exchanging messages with the official account of [hotel LY], the providing unit 132 links information on the request in the talk screen W-1 to the business operator U by transmitting the information on the request to the business operator apparatus 10 of the business operator U who operates the official account of [sushi restaurant ikkyu].

### 4. Flow of Processing According to One Embodiment

### 4-1. Flow of Information Processing (First Example)

A flow of information processing (first example) that is performed by the information processing apparatus 100 according to one embodiment will be described below with reference to FIG. 10. FIG. 10 is a flowchart illustrating an example of the flow of the information processing (first example) that is performed by the information processing apparatus 100 according to one embodiment. The flow of the processing illustrated in FIG. 10 is implemented by the control unit 130 of the information processing apparatus 100. The flow of the processing illustrated in FIG. 10 is repeated while the information processing apparatus 100 is operating.

As illustrated in FIG. 10, when receiving a request to create an alliance from the business operator U (Step S101), the registration unit 131 performs alliance registration (Step S102). For example, the registration unit 131 receives an alliance creation request that is transmitted from the business operator apparatus 10 via the communication unit 110.

When the alliance registration is completed, the registration unit 131 gives an alliance registration completion notice to the business operator U who has transmitted the alliance creation request (Step S103), and terminates the flow of the processing illustrated in FIG. 10. For example, the registration unit 131 transmits the alliance registration completion notice to the business operator apparatus 10 via the communication unit 110 to give a notice to the business operator U.

### 4-2. Flow of Information Processing (Second Example)

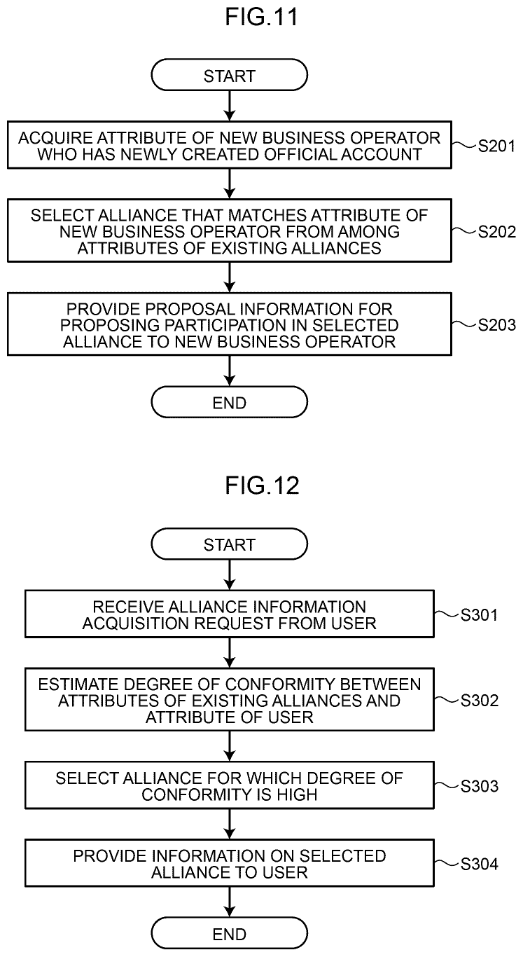

A flow of information processing (second example) that is performed by the information processing apparatus 100 according to one embodiment will be described below with reference to FIG. 11. FIG. 11 is a flowchart illustrating an example of the flow of the information processing (second example) that is performed by the information processing apparatus 100 according to one embodiment. The flow of the processing illustrated in FIG. 11 is implemented by the control unit 130 of the information processing apparatus 100. The flow of the processing illustrated in FIG. 11 is repeated while the information processing apparatus 100 is operating.

As illustrated in FIG. 11, the providing unit 132 acquires an attribute of a new business operator who has newly created an official account, in accordance with new creation of the official account (Step S201).

Furthermore, the providing unit 132 selects an alliance that matches the attribute of the new business operator from among existing alliances based on the attributes of the existing alliances and the attribute of the new business operator (Step S202).

Moreover, the providing unit 132 provides proposal information for proposing participation in the selected alliance to the new business operator (Step S203), and terminates the flow of the process illustrated in FIG. 11. For example, the providing unit 132 provides the proposal information to the new business operator by transmitting the proposal information to the business operator apparatus 10 via the communication unit 110.

### 4-3. Flow of Information Processing (Third Example)

A flow of information processing (third example) that is performed by the information processing apparatus 100 according to one embodiment will be described below with reference to FIG. 12. FIG. 12 is a flowchart illustrating an example of the flow of the information processing (third example) that is performed by the information processing apparatus 100 according to one embodiment. The flow of the processing illustrated in FIG. 12 is implemented by the control unit 130 of the information processing apparatus 100. The flow of the processing illustrated in FIG. 12 is repeated while the information processing apparatus 100 is operating.

As illustrated in FIG. 12, the providing unit 132 receives the alliance information acquisition request from a user of the communication service via the messenger application (Step S301). For example, the providing unit 132 receives the alliance information acquisition request that is transmitted from the user apparatus 20 via the communication unit 110.

Furthermore, the providing unit 132 individually estimates the degree of conformity between attributes of existing alliances and an attribute of the user who has issued the alliance information acquisition request (Step S302), and selects an alliance for which the estimated degree of conformity is high (Step S303).

Moreover, the providing unit 132 acquires information on the selected alliance, provides the acquired information on the alliance to the user who has issued the alliance information acquisition request (Step S304), and terminates the flow of the process illustrated in FIG. 12. For example, the providing unit 132 provides the information on the alliance to the user who has issued the alliance information acquisition request by transmitting the information on the alliance to the user apparatus 20 via the communication unit 110.

### 5. Hardware Configuration

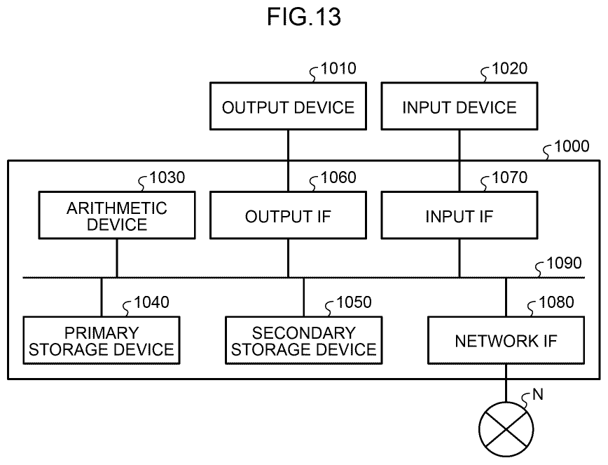

The information processing apparatus 100 according to one embodiment as described above is implemented by, for example, a computer 1000 that is configured as illustrated in FIG. 13. FIG. 13 is a hardware configuration diagram illustrating an example of a computer that implements the functions of the information processing apparatus 100 according to one embodiment.

The computer 1000 is connected to an output device 1010 and an input device 1020, and includes an arithmetic device 1030, a primary storage device 1040, a secondary storage device 1050, an output Interface (IF) 1060, an input IF 1070, and a network IF 1080, all of which are connected to one another via a bus 1090.

The arithmetic device 1030 operates based on a program that is stored in the primary storage device 1040 or the secondary storage device 1050 or a program that is read from the input device 1020, and performs various kinds of processes. The primary storage device 1040 is a memory device, such as a RAM, that temporarily stores therein data that is used for various kinds of calculations by the arithmetic device 1030. Further, the secondary storage device 1050 is a storage device that stores therein data or various kinds of databased that are used for various kinds of calculations by the arithmetic device 1030, and implemented by a Read Only Memory (ROM), an HDD, a flash memory, or the like.

The output IF 1060 is an interface, such as a monitor or a printer, for transmitting output target information to the output device 1010 that outputs various kinds of information, and is implemented by, for example, a connector based on a certain standard, such as a Universal Serial Bus (USB), Digital Visual Interface (DVI), or High Definition Multimedia Interface (HDMI) (registered trademark). Further, the input IF 1070 is an interface for receiving information from various kinds of the input devices 1020, such as a mouse, a keyboard, and n scanner, and is implemented by, for example, a USB or the like.

Meanwhile, the input device 1020 may be a device that reads information from, for example, an optical recording medium, such as a Compact Disc (CD), a Digital Versatile Disc (DVD), or a Phase change rewritable Disk (PD), a magneto-optical recording medium, such as a Magneto-Optical disk (MO), a tape medium, a magnetic recording medium, a semiconductor memory, or the like. Further, the input device 1020 may be an external storage medium, such as a USB memory.

The network IF 1080 receives data from a different apparatus via the network N, sends the data to the arithmetic device 1030, and transmits data generated by the arithmetic device 1030 to a different apparatus via the network N.

The arithmetic device 1030 controls the output device 1010 and the input device 1020 via the output IF 1060 and the input IF 1070. For example, the arithmetic device 1030 loads a program from the input device 1020 or the secondary storage device 1050 onto the primary storage device 1040, and executes the loaded program.

For example, when the computer 1000 functions as the information processing apparatus 100 according to one embodiment, the arithmetic device 1030 of the computer 1000 executes a program (for example, an information processing program) that is loaded on the primary storage device 1040 the primary storage device 1040, and implements the functions of the control unit 130. In other words, the arithmetic device 1030 implements the processes of the information processing apparatus 100 according to one embodiment in cooperation with a program (for example, the information processing program) that is loaded onto the primary storage device 1040.

### 6. Others

In one embodiment as described above, the information processing apparatus 100 may link information on users among official accounts by adopting acceptance by the user of the communication service (for example, the user EUA or the like illustrated in FIG. 2) as a condition.

Furthermore, the information processing apparatus 100 may distribute an alliance advertisement related to an alliance via the messenger application. For example, the information processing apparatus 100 acquires the alliance information that is stored in the alliance information storage unit 123, generates a landing page form the acquired alliance information, and provides the landing page via the messenger application. Moreover, the information processing apparatus 100 is able to select not only information on the official account, but also information that is to be posted on the landing page across the entire service that is connected to the alliance. Examples of the information that may be selected by the information processing apparatus 100 include distribution information on an official account, a method of use of the official account, information on a mini application that is provided by the official account, a reservation link via the official account, and stock information on EC.

Furthermore, the information processing apparatus 100 may distribute all of advertisements of official accounts that belong to the alliance by adopting, as a target, each of users who have registered the official accounts that belong to the alliance as friends.

Moreover, the information processing apparatus 100 may distribute an advertisement in accordance with a situation of the user (for example, the user EUA or the like illustrated in FIG. 2) of the communication service. For example, the providing unit 132 may analyze contents of messages that are exchanged between the user and the official account, selects an advertisement of the official account of a conversation partner or an advertisement of a different official account in the alliance to which the subject official account belongs in accordance with the situation of the user based on the analyzed contents of the messages, and provide the selected advertisement to the user.

Furthermore, the providing unit 132 may select an advertisement in accordance with a situation of the user based on details of a series of actions of the user via a plurality of official accounts that belongs to the same alliance, and provide the selected advertisement to the user. For example, when acquiring action information on a user who uses an official account of a movie theater SH-1 that belongs to an alliance of a shopping mall SM and subsequently uses a restaurants SH-2, the providing unit 132 may provide an advertisement related to a time sale or coupon distribution of a fashion brand SH-3 that belongs to the alliance of the shopping mall SM.

Moreover, in one embodiment as described above, the information processing apparatus 100 may calculate a degree of contribution made by the alliance to each of business operators based on the number of achievements of predetermined conversion from the alliance, and earn a predetermined commission fee from each of the business operators based on the calculated degree of contribution.

For example, it is assumed that the information processing apparatus 100 provides information on an alliance to which the business operator UA, the business operator UB, and the business operator UC belong, and 50 people register the business operator UA as friends, 30 people register the business operator UB as friends, and 20 people register the business operator UC as friends. In this case, the information processing apparatus 100 calculates that a degree of contribution made by the alliance to the business operator UA is 50%, a degree of contribution made by the alliance to the business operator UB is 30%, and a degree of contribution made by the alliance to the business operator UC is 20%. Then, the information processing apparatus 100 calculates a commission fee for each of the business operators U by distributing an advertisement cost that is incurred by provision of the alliance information, and collects the calculated commission fee from each of the business operators U.

Furthermore, for example, when distributing an advertisement of the business operator UB in the official account of the business operator UA and leading to registration of the business operator UB as a friend (when customer transfer is performed), the information processing apparatus 100 may acknowledge a contribution of the business operator UA who has transferred a customer. In this case, the information processing apparatus 100 is able to give, as an expense that is needed for distribution of the advertisement, a part of the commission fee that is collected from the business operator UB to the business operator UA in accordance with the degree of contribution of the business operator UA.

Of the processes described in the embodiments above, all or part of a process described as being performed automatically may also be performed manually. Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified.

Furthermore, the components of the apparatuses illustrated in the drawings are functionally conceptual and do not necessarily have to be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

Moreover, the embodiments described above may be appropriately combined as long as processing contents do not conflict with each other.

Thus, some embodiments of the present application have been described in detail above based on the drawings, but the embodiments are described by way of example, and the present invention may be embodied in various different modes with various modifications and improvement based on knowledge of a person skilled in the art, in addition to the embodiments described in the section of the disclosure of the invention.

In addition, the “unit (section, module, unit)” described above may be replaced with a “means”, a “circuit”, or the like. For example, the control unit may be replaced with a control means or a control circuit.

### 7. Effects

The information processing apparatus 100 according to one embodiment includes the registration unit 131 and the providing unit 132. The registration unit 131, in response to a request from the business operator U who operates an official account (one example of a “business operator account”) that is an account for a business operator and that is created in a mobile messenger application, registers, in an associated manner, a plurality of official accounts that are linked to each other as an alliance (one example of a “business community”). The providing unit 132 provides information on the alliance to a user of the mobile messenger application that is able to exchange messages with the official accounts based on information on the business operator U who belongs to the alliance.

Furthermore, the registration unit 131 registers the plurality of official accounts that are linked to each other as the alliance, in association with an alliance ID (one example of “community identification information”) for identifying the alliance.

Moreover, when receiving a request to acquire information on the alliance from the user, the providing unit 132, estimates a degree of conformity between an attribute of the alliance and an attribute of the user, and selects, as information to be provided to the user, information on the alliance for which the estimated degree of conformity is high.

Furthermore, when providing, as information on the alliance, a list of the official accounts that belong to the alliance, the providing unit 132 estimates a degree of conformity between attributes of the official accounts that belong to the subject alliance and an attribute of the user, re-arranges the list such that the official account with an attribute for which the estimated degree of conformity is higher is displayed with higher priority.

Moreover, when receiving a request to acquire information on the official account from the user, the providing unit 132 selects, as the official account for which information is to be provided to the user, a different official account that is included in the alliance to which the official account registered as a friend by the user belongs and that is not registered as a friend by the user.

Furthermore, when receiving, via a predetermined screen for exchanging a message between the user and a first official account, a request for a second official account that is included in the alliance to which a first business operator account belongs, the providing unit 132 links information on the request to the second official account.

With this configuration, the information processing apparatus 100 according to one embodiment is able to provide, to the user of the communication service (for example, the user EUA or the like) through the messenger application, information on the alliance or information on the official account, and is able to provide seamless user experience in the communication service. In this manner, the information processing apparatus 100 is able to improve usability of the mobile messenger.

Furthermore, the effects as described above may be achieved by a process that is performed by each of the units as described above or a combination of any of processes that are performed by the units.

According to one aspect of the embodiments, it is possible to improve usability of a mobile messenger.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a registration unit that, in response to a request from a business operator who operates a business operator account that is an account for a business operator and that is created in a mobile messenger application, registers, in an associated manner, a plurality of the business operator accounts that are linked to each other as a business community; and
a providing unit that provides information on the business community to a user of the mobile messenger application that is able to exchange messages with the official accounts based on information on the business operator who belongs to the business community.

2. The information processing apparatus according to claim 1, wherein the registration unit registers the plurality of business operators that are linked to each other as the business community, in association with community identification information for identifying the business community.

3. The information processing apparatus according to claim 2, wherein when receiving a request to acquire information on the business community from the user, the providing unit estimates a degree of conformity between an attribute of the business community and an attribute of the user, and selects, as information to be provided to the user, information on the business community for which the estimated degree of conformity is high.

4. The information processing apparatus according to claim 3, wherein when providing, as information on the business community, a list of the business operator accounts that belong to the business community, the providing unit estimates a degree of conformity between attributes of the business operator accounts that belong to the subject business community and an attribute of the user, re-arranges the list such that the official account with an attribute for which the estimated degree of conformity is higher is displayed with higher priority.

5. The information processing apparatus according to claim 2, wherein when receiving a request to acquire information on the business operator account from the user, the providing unit selects, as the business operator account for which information is to be provided to the user, a different business operator account that is included in the business community to which the business operator registered as a friend by the user belongs and that is not registered as a friend by the user.

6. The information processing apparatus according to claim 2, wherein, when receiving, via a predetermined screen for exchanging a message between the user and a first business operator account, a request for a second business operator account that is included in the business community to which the first business operator account belongs, the providing unit links information on the request to the second business operator account.

7. An information processing method that is implemented by a computer, the information processing method comprising:
registering, in response to a request from a business operator who operates a business operator account that is an account for a business operator and that is created in a mobile messenger application, a plurality of the business operator accounts that are linked to each other as a business community, in an associated manner; and
providing information on the business community to a user of the mobile messenger application that is able to exchange messages with the official accounts based on information on the business operator who belongs to the business community.

8. A non-transitory computer readable storage medium having stored therein an information processing program that causes a computer to execute a process, the process comprising:
registering, in response to a request from a business operator who operates a business operator account that is an account for a business operator and that is created in a mobile messenger application, a plurality of the business operator accounts that are linked to each other as a business community, in an associated manner; and
providing information on the business community to a user of the mobile messenger application that is able to exchange messages with the official accounts based on information on the business operator who belongs to the business community.
